(19) United States
(12) Patent Application Publication
(10) Pub. No.: US 2023/0184275 A1
(43) Pub. Date: Jun. 15, 2023

(54) Rotary Connector

(71) Applicant: Erbe Elektromedizin GmbH, Tuebingen (DE)

(72) Inventor: Martina Dueppuis, Pliezhausen (DE)

(21) Appl. No.: 18/065,646

(22) Filed: Dec. 14, 2022

(30) Foreign Application Priority Data
Dec. 15, 2021 (EP) 21214797.9

(51) Int. Cl. F16B 2/18; F16B 21/02; F16B 21/09

(52) U.S. Cl. CPC F16B 2/185; F16B 21/02; F16B 21/09

(57) ABSTRACT

A connection device (12) serves for coupling of two apparatus (10, 11) to be arranged on top of one another or for coupling of an apparatus (10) with an apparatus support (55). The apparatus connection device (12) comprises at least two coupling means, namely the two swivel anchor couplings (20, 21). One embodiment has three coupling means, in which the two swivel anchor couplings are completed by a mounting device (44) that are preferably arranged in a horizontal or in an inclined plane. The mounting device (44) operates according to the hook/eyelet principle while the swivel anchor couplings (20, 21) provide a form-fit locking in that a non-round swivel anchor (25, 28) is axially inserted into an anchor socket (26, 29) and is secured by means of rotation. This connection can be simply established and released and is in addition shock-proof.

### CROSS REFERENCE TO RELATED APPLICATION

This application claims the benefit of European Patent Application No. 21214797.9, filed Dec. 15, 2021, which is incorporated herein by reference in its entirety.

### TECHNICAL FIELD

The invention refers to an apparatus connection device, particularly for connection of electromedical apparatus with each other or for connection of an electromedical apparatus with an apparatus support, e.g. in form of a table or carriage. In addition, the invention refers to an apparatus as well as an apparatus support.

### BACKGROUND

An apparatus support configured as carriage is part of an apparatus system known from US 2016/0228082 A1. A table for the admission of a patient can be connected to this carriage. For connection of the carriage with the table a coupling system is provided comprising rotatable locking bars.

U.S. Pat. No. 6,938,966 B1 discloses a connection system for connection of different cabinets with one another. For this pockets are formed in the side walls of the cabinets. While in one of the cabinets in the respective pockets inserts are attached having a keyhole-shaped receptacle slot, in the pockets of the sidewall of the other cabinet inserts are inserted having a nail head like projection. The projections fit into the keyhole-shaped receptacles and are simply mounted therein.

Another connection system is known from EP 2 209 561 B1. There is proposed a system having a rotary connector comprising a hexagon. From the hexagon cylindrical extensions extend on both sides concentrically to one another, each having a radially projecting nose. The components that have to be connected with each other comprise a circular opening respectively for locating the cylindrical extension therein, wherein each of the openings comprise in addition a radially orientated cutout through which the nose of the cylinder passes. In this manner the rotary connector can be inserted into the opening and can be locked by a rotation.

### SUMMARY

It is one object of the invention to provide an apparatus connection device by means of which apparatus can be connected with one another or also an apparatus can be connected with an apparatus support and, if necessary, can be separated from one another in a quick, reliable and simple manner. In addition, it is another object of the invention to provide an apparatus and an apparatus support that can be connected and separated from one another as necessary.

These objects are solved by means of an apparatus connection device, an apparatus and an apparatus support as described herein.

The apparatus connection device according to the invention can be particularly used for connection of electromedical apparatus with one another or for connection of electromedical apparatus with an apparatus support. Part of the apparatus connection device are a first and a second swivel anchor coupling that are rotatable around individual axes respectively and are, for example, arranged at the bottom of an apparatus. The swivel anchor couplings comprise swivel anchors that are arranged such that their two axes are arranged parallel and with distance to one another. In addition, a mounting device can be part of the apparatus connection device that is arranged with distance to the first swivel anchor coupling as well as the second swivel anchor coupling.

By means of the apparatus connection device according to the invention, an apparatus can be attached to another apparatus or to an apparatus support with a few simple manual manipulations and without endangering the apparatus. This applies particularly also for heavy apparatus that shall under no circumstances slip off and fall down during the coupling procedure. Due to the mounting device, the apparatus is already reliably arranged and held to some extent prior to the fixed coupling, so that it is already secured directly after setting down on another apparatus or apparatus support. The swivel anchor couplings then complete the connection process and create a shake-proof connection.

The mounting device and the swivel anchor couplings are arranged with distance to one another. A three-point mounting results that can be simply established and is reliable thereby. Particularly the mounting device allows a pivot movement of the apparatus around the mounting device after hooking-in so that the swivel anchors of the swivel anchor couplings can easily find their way into the associated anchor sockets.

The swivel anchors are preferably provided with a swivel lever respectively, whereby the swivel levers comprise handle sections that serve to manually rotate the respective swivel anchor. In this manner the swivel anchor couplings can be operated without tools. In addition, the swivel levers and handles of the swivel anchors are preferably at least so long that they project beyond the apparatus bottom and are thus manually accessible, even if the apparatus is coupled with another apparatus or an apparatus support. The handles then project from the gap between the bottom of the apparatus and the support surface of the other apparatus or apparatus support.

The two swivel anchors are rotatable between a locking position and a release position. The release position and the locking position are distanced from one another by a rotation of preferably less than 180°, e.g. rotation about 110°, 90° or 60° or any value between these indications. In doing so, it can be guaranteed that the handle of the lever remains manually accessible in the locking position as well as the release position, because it projects beyond the bottom of the apparatus.

The handle sections of the two swivel levers are preferably orientated on the swivel anchors so that they are orientated parallel to one another in the release position. In the locking position they are preferably orientated parallel or anti-parallel to one another. In doing so, it can be simply recognized by the user respectively whether the swivel anchor is in a position suitable for coupling the apparatus to another apparatus or to an apparatus support or not. In addition, it can be simply recognized whether locking has been carried out or not.

The swivel anchors preferably comprise a locking element respectively, the contour of which deviates from a circle that is concentric relative to the rotation axis of the swivel anchor. The locking element can comprise at least one, preferably however two blades projecting radially from a hub. These blades (or any other non-circular shape) serve to lock the locking element and thus the swivel anchor in a corresponding swivel anchor socket. For example, the two blades can project diametrically to one another in an angle of 180° from a hub of the swivel anchor and thus form an oval contour as a whole. For example, the anchor socket can then be an opening formed in a sheet or plate behind the edge of which the locking element can be swiveled. The opening can be a non-circular opening, e.g. longitudinal opening, e.g. oval opening (an oblong hole) that is formed in an apparatus top side or in an apparatus support. In general, the opening and the locking element can, however, also have a circular shape, if this circle is eccentrically arranged relative to the rotation axis of the locking element.

Preferably the two longitudinal openings that form the two anchor sockets or a part thereof are twisted about an angle relative to one another. This angle can have an amount of preferably and exemplarily 90°. In doing so, a connection between the apparatus and the supporting apparatus or apparatus support results that is not statically overdetermined, rattle-free and shake-proof.

The mounting device preferably comprises a hooking-in element and a receptacle element, wherein the receptacle element comprises a receptacle slot that is orientated in direction toward a line connecting the swivel anchor couplings. The receptacle slot comprises an open and a closed end. The closed end is preferably arranged at the end of the receptacle slot that faces the swivel anchor couplings or a line connecting them, if the receptacle element is arranged at the top side of the lower apparatus or the frame. In case of the arrangement on an inclined surface, the closed end is preferably the lower end in direction of the inclination. Alternatively, the closed end can be the end of the receptacle slot at an end of the receptacle slot facing away from such a line. The latter particularly, if the receptacle element is mounted at the bottom side of the top apparatus. Both configurations allow a particularly intuitive handling and are particularly suitable, even if the apparatus has to be mounted on a mono-pitched support surface having a slope toward the apparatus back side. The mounting device is preferably arranged in an area of the support surface away from the user, while the anchor sockets are arranged in an area near the user. If the user hooks-in the apparatus into the mounting device, it can no longer slide off the mono-pitched support surface and is in so far already temporarily reliably held.

In the apparatus according to the invention both swivel anchors and either a hooking-in element or a receptacle element are arranged on its bottom. The swivel anchors and the hooking-in element or receptacle element respectively form one half of the three couplings of the apparatus connection device. The two first couplings are preferably defined by the first and the second swivel anchor coupling, while the third coupling is defined by the mounting device. The swivel anchors and the hooking-in element or receptacle element are arranged in a triangle relative to one another. Particularly preferred is an arrangement in an isosceles triangle, whereby the two legs of equal length are defined by one swivel anchor coupling and the mounting device.

On an apparatus support forming part of the invention or an apparatus configured for stacking at a respective top side the first and the second anchor socket as well as a hooking-in element or a receptacle element can be provided that together form again a triangle. This triangle corresponds to the triangle of the swivel anchors and the mounting or receptacle element of an apparatus that can be stacked thereon.

By means of the invention a connection system is provided with which apparatus in an operation room can be reliably connected with one another or with an apparatus support in order to form a stack or tower that withstands also unintentional shocks or other loads, as they may occur in emergency situations in the operation room or during movement of the apparatus support.

### BRIEF DESCRIPTION OF THE DRAWINGS

Further details of advantageous embodiments of the invention are derived from the drawing as well as the corresponding description and the dependent claims. The drawings show:

FIG. 1 two apparatus that can be stacked having an apparatus connection device according to the invention in a perspective illustration,

FIG. 2 a first swivel anchor in a perspective schematic illustration,

FIG. 3 a second swivel anchor in a schematic perspective illustration,

FIG. 4 a hooking-in element in a schematic illustration,

FIG. 5 a receptacle element in a perspective schematic illustration,

FIG. 6 an apparatus according to the invention and an associated apparatus support in a schematic perspective illustration respectively.

### DETAILED DESCRIPTION

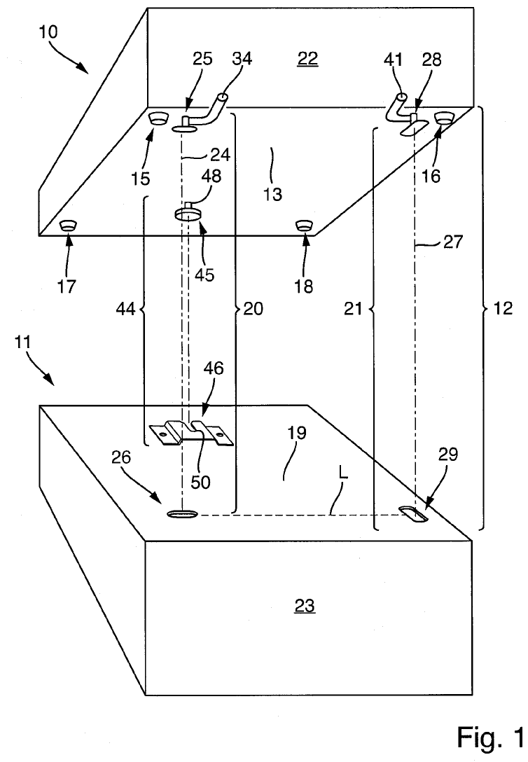

In FIG. 1 two medical apparatus 10, 11 are illustrated to which an apparatus connection device 12 is assigned in order to be able to couple the two apparatus 10, 11 with each other. The medical apparatus 10, 11 can be apparatus for supply of medical instruments with current, voltage, operating media such as cryo-fluids, purge media, gases and the like.

The apparatus 10 comprises an apparatus bottom 13 with apparatus feet 15, 16, 17, 18 arranged thereon. The apparatus feet 15-18 are preferably arranged near the edge and corner and allow placing the apparatus 10 on the top side 19, which is planar, for example, of the lower medical apparatus 11. The apparatus 10 and 11 can thereby have equal or slightly different contours.

The apparatus connection device 12 comprises a first swivel anchor coupling 20 as well as a second swivel anchor coupling 21 that are both preferably arranged near the apparatus backsides 22, 23 on the bottom 13 and on the top side 19 of the two apparatus 10, 11. Alternatively, they can also be arranged near the front sides or near the flanks of the apparatus 10, 11.

Part of the first swivel anchor coupling 20 is a swivel anchor 25 that is rotatably arranged around a first axis 24 on the bottom 13 and an anchor socket 26 assigned thereto arranged on the top side 19 of the lower apparatus 11.

Similarly part of the second swivel anchor coupling 21 is a second swivel anchor 28 rotatably supported around a second axis 27 to which a second swivel anchor socket 29 is assigned arranged in the top side 19 of the second apparatus 11.

The rotation axes 24, 27 are orientated parallel and with distance to one another. Preferably the two swivel anchors 25, 28 are arranged in the vicinity of the apparatus feet 15, 16. The two rotation axes 24, 27 are preferably orientated orthogonal to the apparatus bottom 13 and thus also orthogonal to the top side 19, at least if the apparatus 10 is placed on the apparatus 11.

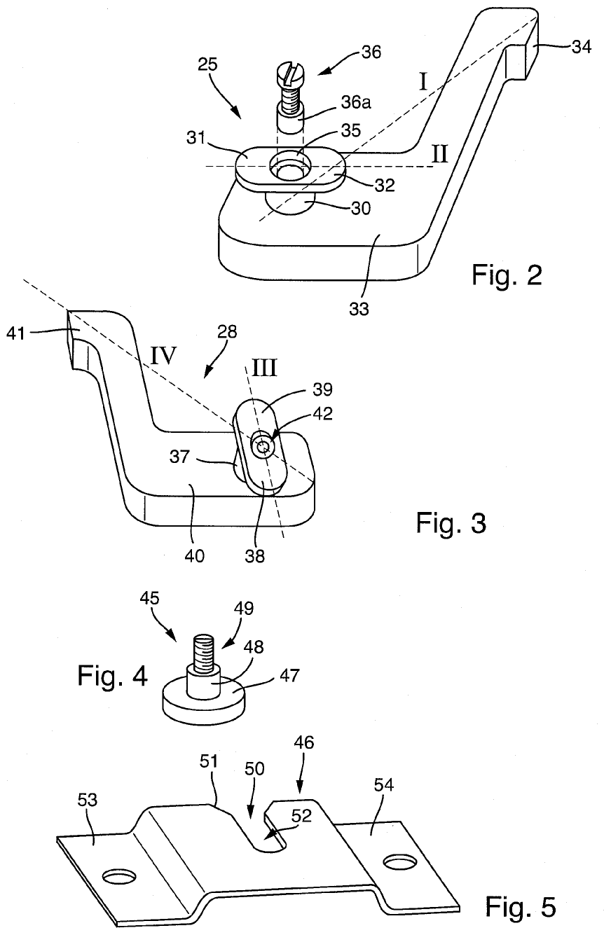

The swivel anchor 25 illustrated separately in FIG. 2 comprises two blades 31, 32 that project diametrically in radial direction from a hub 30, whereby the blades 31, 32 together form a locking element having an oval contour or defining another suitable contour. The hub 30 is connected in a torque-proof manner with a lever 33 that is orientated in the swivel anchor 25 equal to the blades 31, 32. The lever 33 comprises a bend, for example of 90°, and transitions into a handle 34. The handle 34 and the hub 30 thereby define a line that is arranged in an angle, e.g. an angle of 45°, relative to a line defined by the two blades 31, 32. The two lines I, II are indicated in dashed lines in FIG. 2.

The hub 30 and the lever 33 comprise a central opening 35 that serves for locating an attachment screw 36 therein for swivel support of the swivel anchor 25 at the bottom 13 of apparatus 10. For this purpose bottom 13 comprises a respective threaded hole into which the attachment screw 36 can be screwed in order to support the swivel anchor 25 pivotably on the apparatus 10. The attachment screw 36 can be a fitting screw or a screw 36 provided with a sleeve 36a. The sleeve 36a can be held in a loss-proof manner on the screw 36 by means of a locking washer. Other means for rotatable or pivotable attachment of the swivel anchor 25 at the bottom 13 are possible.

The second swivel anchor 28 of the second swivel anchor coupling 21 distinguishes from the first swivel anchor 25, as apparent from FIG. 3 and the comparison to FIG. 2. Just like the first swivel anchor 25 the second swivel anchor 28 comprises a hub 37 from one end of which two blades 38, 39 extend away in opposite radial directions (diametrical directions) forming a locking element. The two blades 38, 39 define an oval contour or also another non-circular contour. A lever 40 that is angled in a certain distance to the hub 37 and transitions into a handle 41 adjoins the other end of hub 37. While the lever 33 is configured being bent to the left and accordingly comprises a 90° bend orientated to the left, the lever 40 is configured in a manner bent to the right and comprises with view from the hub 37 a bend to the right. While the blades 31, 32 are first orientated in direction of the part of the lever 33 adjoining the hub 30 according to line II, the blades 38, 39, the diametrical directions of which define the line III, are orientated transverse to the part of the lever 40 adjoining the hub 37. The handle 41 in turn defines a line IV with hub 37 that defines an acute angle, e.g. of 45°, with the line III defined by the blades 38, 39.

Also swivel anchor 28 comprises an attachment opening 42 extending through the hub 37 and the lever 40 that serves for location of a not further illustrated attachment screw or another attachment means therein for pivotable support of the swivel anchor 28 at the bottom 13 of apparatus 10.

The anchor sockets 26, 29 associated to the swivel anchors 25, 28 are attached at the top side 19 at locations through which the rotation axes 24, 27 of the swivel anchors 25, 28 extend. The anchor sockets 26, 29 that are, for example, configured as oval openings, correspond with the orientations of the blades 31, 32 or 38, 39 of swivel anchors 25, 28, if they are in the release position illustrated in FIG. 1. As apparent, the longitudinal orientations of the oval anchor sockets 26, 29 are twisted about an angle of, e.g. 90°, to one another.

In an embodiment advantageous in many cases, a mounting device 44 is in addition part of the apparatus connection device 12, wherein the mounting device 44 is arranged with distance to the first rotation axis 24 as well as the second rotation axis 27. Preferably the mounting device 44 and the swivel anchor couplings 20, 21 are arranged in a common plane that is arranged parallel to the bottom 13 and the top side 19.

The mounting device 44 comprises a hooking-in element 45, as apparent from FIG. 4 by way of example, and a receptacle element 46 that is illustrated in FIG. 5 by way of example. For example, the hooking-in element can be configured as screw having a head 47 that projects from a shank 48 that transitions into a threaded shank 49.

For example, the receptacle element 46 can be configured as angled sheet part at which a receptacle slot 50 is provided as cut-out opened to an edge comprising a funnel insertion section 51 and a locking slot 52 limited by parallel flanks. The closed end of the receptacle slot 50 is preferably orientated toward the center of a virtual triangle, the corners of which are defined by the mounting device 44 and the swivel anchor couplings 20, 21.

On both sides of the central section comprising a receptacle slot 50, attachment portions 53, 54 can be provided by means of which the central part of the receptacle element 46 comprising the receptacle slot 50 can be held with distance to the respective support, e.g. the top side 19 of apparatus 11, that is sufficient for locating the head 47 therein.

It is possible to arrange hooking-in element 45 at the bottom 13 and the receptacle element 46 at the top side 19, as illustrated in FIG. 1. It is, however, also well possible to reverse the association and to arrange the hooking-in element 45 at the top side 19 and the receptacle element 46 at the bottom 13. In the latter case it is advantageous to mount the receptacle element 46 reversely so that the funnel insertion section 51 is orientated toward the center of the virtual triangle, the edges of which are defined by the mounting device 44 and the swivel anchor couplings 20, 21.

While the height of the hooking-in element 45 screwed into the bottom 13 or the top side 19 as well as the height of the receptacle element 46 is preferably lower than the height of the apparatus feet 17, 18, the height of the swivel anchors 25, 28 is preferably higher than the height of the apparatus feet 15, 16. In doing so, the locking elements formed by the blades 31, 32, 38, 39 find their way through the openings of the anchor sockets 26, 29 forming locking element receptacles, if the apparatus 10 is placed on the apparatus 11.

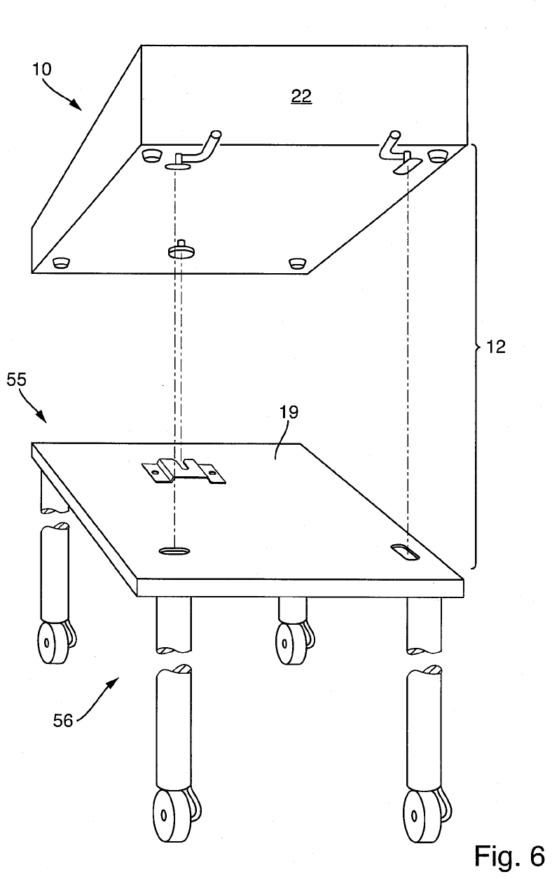

While it has been assumed in the description relating to FIGS. 1-5 that the apparatus connection device 12 connects two apparatus 10, 11 with one another, the apparatus connection device 12 can also be provided to connect an apparatus, such as the apparatus 10, with an apparatus support 55 according to FIG. 6. The apparatus support 55 consists of a frame 56 that is, for example, movably configured, the top side 19 of which corresponds to the top side 19 of apparatus 11. The explanations with regard to the apparatus connection device 12 and their elements as well as the explanations with regard to the configuration of the elements at and on the top side 19 of apparatus 11 made above apply accordingly to the top side 19 of apparatus support 55.

The apparatus connection device described so far functions as follows:

It is assumed that the apparatus 10 is to be attached to apparatus 11. First, as for example illustrated in FIG. 1, it is thereby placed on the top side 19 of apparatus 11 slightly offset to the back (into the image plane) so that the hooking-in element 45, particularly the head 47, is in straight extension to the receptacle slot 50 in the vicinity thereof. In doing so, the apparatus feet 17, 18 and the swivel couplings 25, 28 abut against the top side 19. If the apparatus 10 is now pulled by the user standing in front of the back sides 22, 23 of apparatus 10, 11, shank 48 moves into the receptacle slot 50, whereby the mounting device 44 couples, i.e. is in engagement, and the apparatus 10, 11 are already provisionally secured to one another.

As soon as shank 48 has been completely moved into the receptacle slot 50, the locking elements formed by blades 31, 32, 38, 39 fall into the oval openings of the anchor sockets 26, 29. The user can now move the two handles 34, 41 away from one another, whereby the swivel anchors 25, 28 rotate around approximately 90° . In doing so, a form-fit locking of the swivel anchors 25, 28 in the anchor receptacles 26, 29 result. The apparatus 10, 11 are thus secured to one another.

The disassembly is carried out in reversed operating order and can therefore be carried out without tools, just like the assembly.

The assembly and disassembly of apparatus 10 on apparatus support 55 is carried out accordingly. In both cases it also applies that a rotation of the swivel anchors 25, 28 with opposite sense of rotation is not necessary. It is also possible to configure the two levers 33, 40 of swivel anchors 25, 28 angled in the same direction, e.g. angled to the right or angled to the left. The locking movements of the two swivel anchors 25, 28 can then be executed in the same direction. Likewise the release movements are carried out in the same, but opposite rotation direction.

A connection device 12 according to the invention serves for coupling of two apparatus 10, 11 to be arranged on top of one another or for coupling of an apparatus 10 with an apparatus support 55. The apparatus connection device 12 comprises at least two coupling means, namely the two swivel anchor couplings 20, 21. An embodiment is preferred having three coupling means, in which the two swivel anchor couplings are completed by a mounting device 44 that are preferably arranged in a horizontal or in an inclined plane. The mounting device 44 operates according to the hook/eyelet principle while the swivel anchor couplings 20, 21 provide a form-fit locking in that a non-round swivel anchor 25, 28 is axially inserted into an anchor socket 26, 29 and is secured by means of rotation. This connection can be simply established and released and is in addition shock-proof.

### REFERENCE SIGNS

10 first medical apparatus
11 second medical apparatus
12 apparatus connection device
13 bottom
15-18 apparatus feet
19 top side
20 first swivel anchor coupling
21 second swivel anchor coupling
L line connecting the swivel anchor couplings 20, 21
22 backside of apparatus 10
23 backside of apparatus 11
24 first axis
25 first swivel anchor
26 first swivel anchor socket
27 second axis
28 second swivel anchor
29 second swivel anchor socket
30 hub
31, 32 blade
33 lever
34 handle
I, II lines
35 opening
36 attachment screw
36a sleeve
37 hub
38, 39 blade
40 lever
41 handle
III, IV lines
42 opening
44 mounting device
45 hooking-in element
46 receptacle element
47 head
48 shank
49 threaded shank
50 receptacle slot
51 insertion section
52 locking slot
53, 54 attachment portions
55 apparatus support
56 frame

1. An apparatus connection device (12) for
connection of electromedical apparatus, the apparatus connection device (12) comprising:
a first swivel anchor coupling (20) comprising a first swivel anchor (25) rotatable around a first axis (24) and a first anchor socket (26), wherein the first swivel anchor (25) is configured to anchored in the first anchor socket (26), and
a second swivel anchor coupling (21) comprising a second swivel anchor (28) rotatable around a second axis (27) and a second anchor socket (29), wherein the second swivel anchor (28) is configured to be anchored in the second anchor socket (29),
wherein the first axis (24) and the second axis (27) are arranged parallel and with distance to one another.

2. The apparatus connection device according to claim 1, further comprising a mounting device (44) that is arranged with distance to the first swivel anchor coupling (20) and the second swivel anchor coupling (21).

3. The apparatus connection device according to claim 1,
wherein the first swivel anchor (25) is connected with a first swivel lever (33) comprising a first handle (34) for manual rotation of the first swivel anchor (25) and wherein the second swivel anchor (28) is connected with a second swivel lever (40) comprising a second handle (41) for manual rotation of the second swivel anchor (28).

4. The apparatus connection device according to claim 1,
wherein the first and second swivel anchors (25, 28) are configured to can be rotated between a locking position and a release position.

5. The apparatus connection device according to claim 4,
wherein the first and second swivel anchors are configured to rotate one-quarter of one rotation to shift between the locking position and the release position thereof.

6. The apparatus connection device according to claim 3,
wherein the first and second swivel levers (33, 40) are oriented at the respective first and second swivel anchors (25, 28) so that the first and second swivel levers (33, 40) have sections that are oriented parallel to one another respectively in a release position.

7. The apparatus connection device according to claim 3,
wherein the first and second swivel levers (33, 40) are oriented at the respective first and second swivel anchors (25, 28) so that the first and second swivel levers (33, 40) have sections oriented parallel or antiparallel to one another in a locking position.

8. The apparatus connection device according to claim 1,
wherein the first swivel anchor (25) comprises a first locking member (31-32) and the second swivel anchor (28) comprises a second locking member (38-39), wherein the first and second locking members (31-32, 38-39) each comprise two blades (31, 32, 38, 39) that project radially from a hub (30, 37).

9. The apparatus connection device according to claim 8,
wherein the blades (31, 32) of the first locking member (31-32) are oriented transversely to the blades (38, 39) of the second locking member (38-39) when first and second locking members (31, 32, 38, 39) are in a locking position.

10. The [[A]]apparatus connection device according to claim 1,
wherein the first anchor socket (26) comprises a first locking member receptacle having a first non-circular opening and the second anchor socket (29) comprises a second locking member receptacle having a second non-circular opening.

11. The apparatus connection device according to claim 10,
wherein the second non-circular opening is oriented transversely relative to the first non-circular opening.

12. The apparatus connection device according to claim 2,
wherein the mounting device (44) comprises a hooking-in element (45) and a receptacle element (46), wherein the receptacle element (46) comprises a receptacle slot (50) that is orientated away from an imaginary line (L) extending between the first and second swivel anchor couplings (20, 21) and wherein the receptacle slot (50) comprises a section having a width that is less than a width of the hooking-in element (45).

13. An apparatus (10), comprising:
a bottom (13) at which a first swivel anchor (25) is rotatably connected about a first axis (24),
a second swivel anchor (28) rotatably connected to the bottom (13) about a second axis (27) that is arranged parallel and with distance to the first axis (24), and
a hooking-in element (45) or a receptacle element (46) that is arranged with distance to the first swivel anchor (25) and the second swivel anchor (28).

14. The apparatus according to claim 13, wherein the first and second swivel anchors (25, 28) and the hooking-in element or receptacle element (45, 46) are arranged in a triangle.

15. An apparatus, comprising:
a top side (19) at which a first anchor socket (26) and a second anchor socket (29) are provided, wherein the first and second anchor sockets (26, 29) are arranged with distance to one another, and
a hooking-in element (45) or a receptacle element (46) provided at the top side (19) that is arranged with distance to the first anchor socket (26) and the second anchor socket (29).
